(19) United States
(12) Patent Application Publication
(10) Pub. No.: US 2008/0187808 A1
(43) Pub. Date: Aug. 7, 2008

(54) Integrated Humidified Fuel Cell Assembly

(76) Inventors: Jorgen Schjerning Lundsgaard, Svendborg (DK); Henning Frederiksen, Svendborg (DK); Madeleine Odgaard, Odense M (DK); John Kaas, Svendborg (DK)

Correspondence Address: LICATA & TYRRELL P.C., 66 E. MAIN STREET, MARLTON, NJ, 08053, US

(21) Appl. No.: 11/908,308

(22) PCT Filed: Mar. 14, 2006
(86) PCT No.: PCT/IB2006/000553

§ 371 Date: Sep. 11, 2007

Related U.S. Application Data
(60) Provisional application No. 60/662,294, filed on Mar. 16, 2005.

(51) Int. Cl. H01M 8/02

(52) U.S. Cl. 429/34

(57) ABSTRACT

A fuel cell stack (2) constructed and assembled so that a membrane-type humidifying exchanger (1) enables diffusional contact of a re-circulating aqueous liquid fuel supply and the oxidant air stream supplied to the fuel cell stack (2) is provided. The assembly is configured so that the fuel cell stack (2) is mounted together with other ancillaries on a base provided by the membrane-type humidifying exchanger (1).

This patent application claims the benefit of priority from U.S. Provisional Application Ser. No. 60/662,294, filed Mar. 16, 2005, teachings of which are herein incorporated by reference in their entirety.

### FIELD OF THE INVENTION

The present invention relates to modified fuel cells which use aqueous solutions of alcohol such as methanol and which provide improved distribution of temperature and humidity. Important savings in excess air supply rate, operation stability, environmental sensitivity, and heat control are obtained using this integrated humidified fuel cell assembly.

### BACKGROUND OF THE INVENTION

Fuel cells are electrochemical energy conversion devices considered as a possible alternative to internal combustion engines. Fuel cells convert a hydrogen containing fuel such as methanol or hydrogen to electrical energy by an oxidation reaction. A by-product of this reaction is water. Adequate output voltage entails the assembly of multiple fuel cells, connected in series, into fuel cell stacks.

Various proton exchange membrane (PEM) fuel cells have been described.

One type of PEM fuel cell comprises a solid polymer electrolyte (SPE) membrane, such as a sulfonated fluorinated polymer membrane material known as Nafion, which provides ion exchange between cathode and anode electrodes. Various configurations of SPE fuel cells as well as methods for their preparation have been described. See e.g. U.S. Pat. No. 4,469,579; U.S. Pat. No. 4,826,554; U.S. Pat. No. 5,211,984; U.S. Pat. No. 5,272,017; U.S. Pat. No. 5,316,871; U.S. Pat. No. 5,399,184; U.S. Pat. No. 5,472,799; U.S. Pat. No. 5,474,857; and U.S. Pat. No. 5,702,755.

In Direct Methanol Fuel Cells (DFMC) the electrochemical oxidation with oxygen from the air supplied.

The air supply in present fuel cell system serves to lead excess heat produced in the electrochemical oxidation away from the cell. At the same time air passing through the cell becomes humidified by the water and takes up the carbon dioxide produced so that spent air removes reactants from the reaction.

It is an important function of this integrated assembly that the use of excess air to remove reactants and cool the cell stack is considerably reduced. The integrated assembly also makes the use of connections and tubes joining the separate functional units unnecessary. A further advantage is friction losses that constrictions of fluid flow in tubes and fittings are reduced.

### BRIEF DESCRIPTION OF THE FIGURES

FIG. 1 is a diagram of a fuel cell assembly of the present invention.

### DETAILED DESCRIPTION OF THE INVENTION

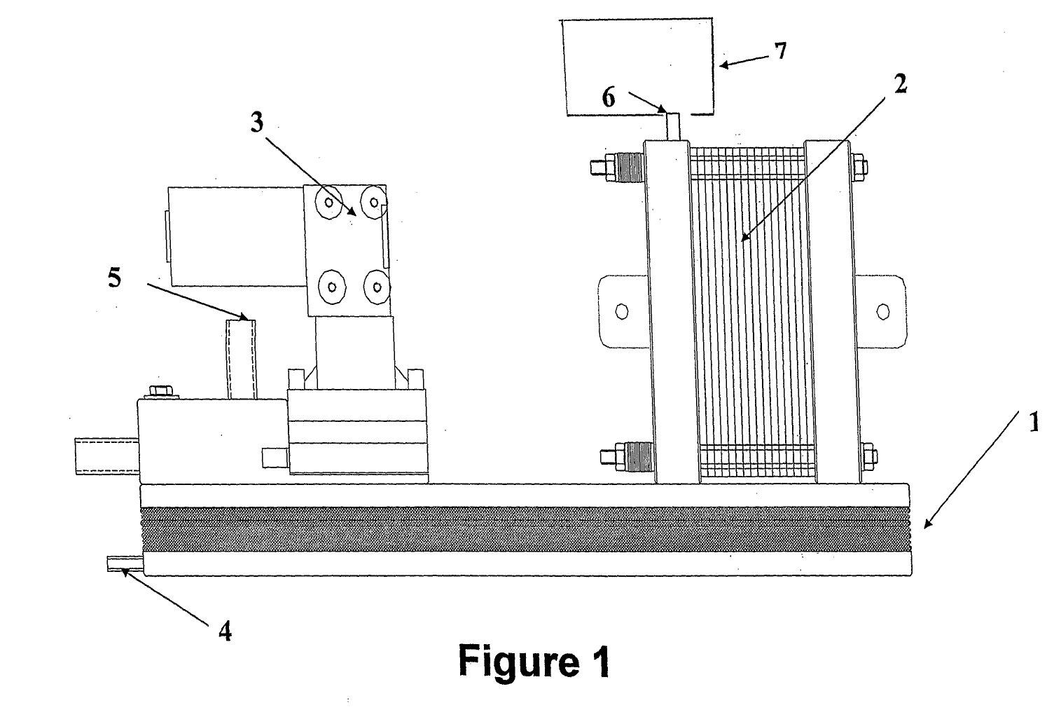

FIG. 1 shows the general principles of construction of the fuel cell assembly of the present invention. A membrane-type humidifying exchanger 1 is used as the constructional base for mounting of the cell stack 2. The fuel cell stack in the present embodiment is built up using dual function bipolar separator plates according to PCT/EP2005/002243 filed Feb. 15, 2005, teachings of which are herein incorporated by reference in their entirety. However, other fuel cell designs may also be used in the present invention.

Clean air is pumped in through the inlet port 5 and circulated in the membrane-type humidifying exchanger 1 and supplied to the cell stack 2 as oxidant using the primary air pump and the air distributor 3.

The membrane-type humidifying exchanger 1 is a conventional device widely used in providing a supply of humidified air to fuel cells. Clean air is pumped into the assembly via the inlet port 5 to the membrane-type humidifying exchanger 1 where it contacts a semi-porous membrane separating the circulating fluid fuel such as 1 molar methanol from the air phase. The semi-porous membrane allows the diffusion of water to and from the contacting phases. This ensures that the air leaving the membrane-type humidifying exchanger 1 is fully humidified and heated by the hot and denuded liquid fuel, which exits the fuel cell stack 2 via the sealed outlet. Air is then returned to the air pump 3 and supplemented by new air through the inlet port 5 before being recycled. Water which may have condensed in the cool, re-circulating air is purged via a water vent 4.

Fuel from the fuel cell stack 2 is also circulated through the membrane-type humidifying exchange 1 and returned to the fuel cell stack 2 via a sealed outlet. The fuel circulation and the fuel concentration are maintained by using a fuel circulation device 7, preferably a gas driven fuel circulation device such as described in PCT/EP2004/013397, filed Nov. 18, 2004, teachings of which are herein incorporated by reference in their entirety) attached to fuel inlet and outlet pipes 6. As will be understood by the skilled artisan upon reading this disclosure, however, alternative fuel circulation devices can be used.

In conventional non-integrated systems it is necessary to maintain a high level of excess air supply in order for excessive condensation of water in the spent air stream to be avoided. Further, frequent purging with high air flow is necessary at intervals affected by the humidity and temperature of the oxidizing air supply.

The molar air to fuel ratio (λ) required for normal stable operation of previously used configurations is from a λ factor of 2.5 to 3.5. Cell operation with the configuration of the present invention requires a considerably lower λ value of 2.0.

Further, purging is only necessary as a part of normal startup procedure. This enables a reduction in the energy drain for operating ancillary equipment such as the air pump, thus providing for improved overall efficiency. Further advantages result from the optimal humidification of air supplied to the cell so that variations in ambient air temperature and humidity do not affect the operation of the cell and condensation is better controlled so that vapor-locks and water blockages are avoided. Further advantages are that evaporation losses from the re-circulating fuel are reduced so that topping up of the fluid level becomes less frequent. The integrated system thus provides significantly improved stability of operation especially where fuel cells of the DMFC type are used in stand alone or in remote applications.

What is claimed is:

1. An integrated humidified fuel cell assembly comprising:
(a) a fuel cell stack;
(b) a membrane-type humidifying exchanger upon which the fuel cell stack is mounted which supplies oxidant to the fuel cell stack;
(c) a primary air pump and air distributor which pumps and circulates clean air from a clean air inlet port to the membrane-type humidifying exchanger;
(d) a clean air inlet port with provides clean air to the primary air pump and air distributor;
(e) a fuel circulation device;
(f) a fuel inlet pipe and a fuel outlet pipe which connect the fuel circulation device to the fuel cell stack; and
(g) a water vent for purging of any water which condenses in cool, re-circulated air in the membrane-type humidifying exchanger.

2. The integrated humidified fuel cell assembly of claim 1 wherein the fuel cell stack comprises dual function bipolar separator plates.

3. The integrated humidified fuel cell assembly of claim 1 wherein the fuel circulation device is a gas driven fuel circulation device.
